(19) United States
(12) Patent Application Publication
(10) Pub. No.: US 2026/0366633 A1
(43) Pub. Date: Nov. 19, 2026

(54) INFLATION SYSTEM AND RELATED VALVE ASSEMBLY

(71) Applicant: Universal Trim Supply Co., Ltd., New Taipei City (TW)

(72) Inventors: Chih-Hung Chen, New Taipei City (TW); Shih-Sheng Yang, Taipei City (TW)

(73) Assignee: Universal Trim Supply Co., Ltd., New Taipei City (TW)

(21) Appl. No.: 19/209,745

(22) Filed: May 15, 2025

(51) Int. Cl. F16K 15/20; F04B 45/04; F16K 15/14

(52) U.S. Cl. CPC F16K 15/202; F16K 15/148; F04B 45/045

(57) ABSTRACT

An inflation system is provided and includes a container and a valve assembly. The valve assembly includes a seat member disposed on the container and a valve member disposed through the seat member. The inflation pump is configured to detachably engage with the seat member for introducing air into the container. The valve member in a first state is configured to abut against a first side and a second side of the seat member for allowing the air to flow into the container and preventing the air from flowing out of the container. The valve member in a second state is configured to abut against the first side of the seat member and separate from the second side of the seat member for allowing the air to flow into and out of the container. Besides, a related valve assembly is also provided.

### BACKGROUND OF THE INVENTION

### 1. Field of the Invention

The present invention relates to an inflation product, and more specifically, to an inflation system with easy inflation and deflation operation and a related valve assembly.

### 2. Description of the Prior Art

There are various inflation products available in the market. The inflation product typically requires a one-way valve configured to switch between different states to selectively either allow air to enter a containing component in one direction and prevent the air from exiting the containing component, or allow the air to enter and exit the containing component in both directions. However, the conventional one-way valve fails to provide intuitive operation. Therefore, an improvement is urgently needed.

### SUMMARY OF THE INVENTION

It is an objective of the present invention to provide to an inflation system with easy inflation and deflation operation and a related valve assembly for solving the aforementioned drawbacks.

In order to achieve the aforementioned objective, the present invention discloses an inflation system. The inflation system includes a container, a valve assembly and an inflation pump. The valve assembly includes a seat member disposed on the container, and a valve member disposed through the seat member. The inflation pump is configured to detachably engage with the seat member for introducing air into the container. When the valve member is in a first state, the valve member is configured to abut against a first side and a second side of the seat member for allowing the air to flow into the container and preventing the air from flowing out of the container. When the valve member is in a second state, the valve member is configured to abut against the first side of the seat member and separate from the second side of the seat member for allowing the air to flow into and out of the container.

According to an embodiment of the present invention, the valve member is made of resilient material.

According to an embodiment of the present invention, the valve member includes a first portion, a second portion opposite to the first portion, and a third portion connected between the first portion and the second portion and movably disposed through the seat member.

According to an embodiment of the present invention, when the valve member is in the first state, the first portion and the second portion of the valve member are configured to abut against the first side and the second side of the seat member, respectively.

According to an embodiment of the present invention, when the valve member is in the second state, the first portion of the valve member is configured to abut against the first side of the seat member and the second portion of the valve member is configured to separate from the second side of the seat member.

According to an embodiment of the present invention, a plurality of protruding structures are formed on the first side of the seat member and configured to abut against the valve member, and a recessed channel is formed between two adjacent protruding structures of the plurality of protruding structures and configured to provide an air passage.

According to an embodiment of the present invention, an inclined sealing structure is formed on the second side of the seat member and configured to abut against the valve member.

According to an embodiment of the present invention, a tapered through hole is formed on the seat member where the valve member passes through.

According to an embodiment of the present invention, a first engaging structure is formed on the seat member, and a second engaging structure is formed on the inflation pump and configured to detachably engage with the first engaging structure.

According to an embodiment of the present invention, the first engaging structure is an engaging recess, and the second engaging structure is an engaging protrusion.

According to an embodiment of the present invention, the inflation pump includes a first resilient member configured to engage with the seat member and a second resilient member configured to detachably mount on the first resilient member. An air outlet is formed on the first resilient member, and an air inlet is formed on the second resilient member.

According to an embodiment of the present invention, the air outlet is configured to at least partially receive the valve member and the seat member when the first resilient member is engaged with the seat member.

In order to achieve the aforementioned objective, the present invention further discloses a valve assembly adapted for a container. The valve assembly includes a seat member disposed on the container, and a valve member disposed through the seat member. When the valve member is in a first state, the valve member is configured to abut against a first side and a second side of the seat member for allowing air to flow into the container and preventing the air from flowing out of the container. When the valve member is in a second state, the valve member is configured to abut against the first side of the seat member and separate from the second side of the seat member for allowing the air to flow into and out of the container.

According to an embodiment of the present invention, the valve member is made of resilient material.

According to an embodiment of the present invention, the valve member includes a first portion, a second portion opposite to the first portion, and a third portion connected between the first portion and the second portion and movably disposed through the seat member.

According to an embodiment of the present invention, when the valve member is in the first state, the first portion and the second portion of the valve member are configured to abut against the first side and the second side of the seat member, respectively.

According to an embodiment of the present invention, when the valve member is in the second state, the first portion of the valve member is configured to abut against the first side of the seat member and the second portion of the valve member is configured to separate from the second side of the seat member.

According to an embodiment of the present invention, a plurality of protruding structures are formed on the first side of the seat member and configured to abut against the valve member, and a recessed channel is formed between two adjacent protruding structures of the plurality of protruding structures and configured to provide an air passage.

According to an embodiment of the present invention, an inclined sealing structure is formed on the second side of the seat member and configured to abut against the valve member.

According to an embodiment of the present invention, a tapered through hole is formed on the seat member where the valve member passes through.

In summary, the valve member is configured to switch from the first state to the second state in response to resilient deformation of the valve member caused by a pressing force applied onto the valve member, thereby allowing airflows to flow into and out of the container for air deflation, and the valve member is further configured to return from the second state to the first state in response to resilient recovery of the valve member resulting from release of the pressing force, thereby allowing an airflow to flow into the container and preventing an airflow from flowing out of the container for air inflation. Therefore, the present invention provides more intuitive operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an inflation system according to an embodiment of the present invention.

FIG. 2 and FIG. 3 are exploded diagrams of the inflation system at different views according to the embodiment of the present invention.

FIG. 4 is a sectional diagram of the inflation system according to the embodiment of the present invention.

FIG. 5 and FIG. 6 are diagrams of a seat member at different views according to the embodiment of the present invention.

FIG. 7 and FIG. 8 are diagrams of a valve member at different views according to the embodiment of the present invention.

FIG. 9 is a diagram illustrating that the valve member is in a first state for air inflation according to the embodiment of the present invention.

FIG. 10 is a diagram illustrating that the valve member is in a second state for air deflation according to the embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure(s) being described. The members of the present invention can be positioned in a number of different orientations. As such, the directional terminology is used for purposes of illustration and is in no way limiting. Accordingly, the drawings and descriptions will be regarded as illustrative in nature and not as restrictive. Also, if not specified, the term “connect” is intended to mean either an indirect or direct mechanical connection. Thus, if a first device is connected to a second device, that connection may be through a direct mechanical connection, or through an indirect mechanical connection via other devices and connections.

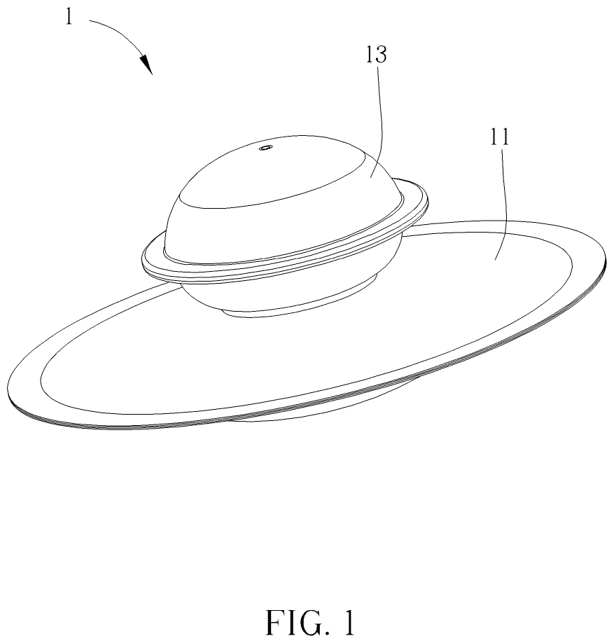

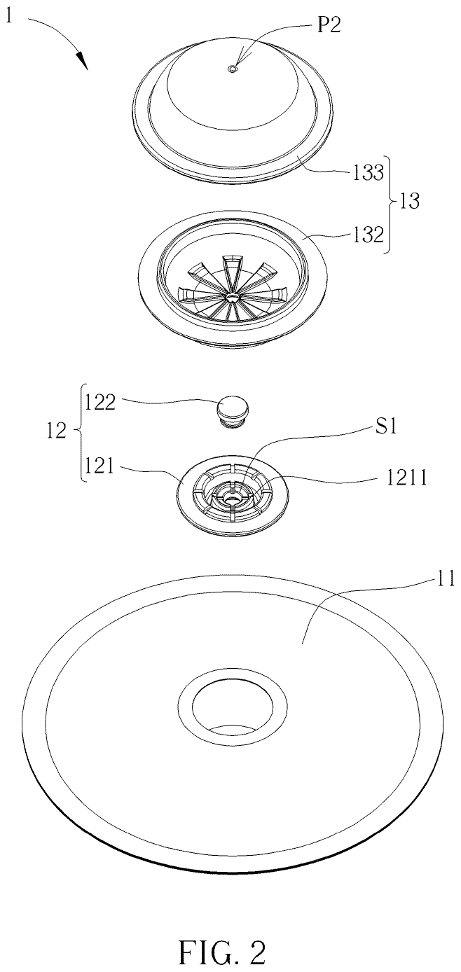

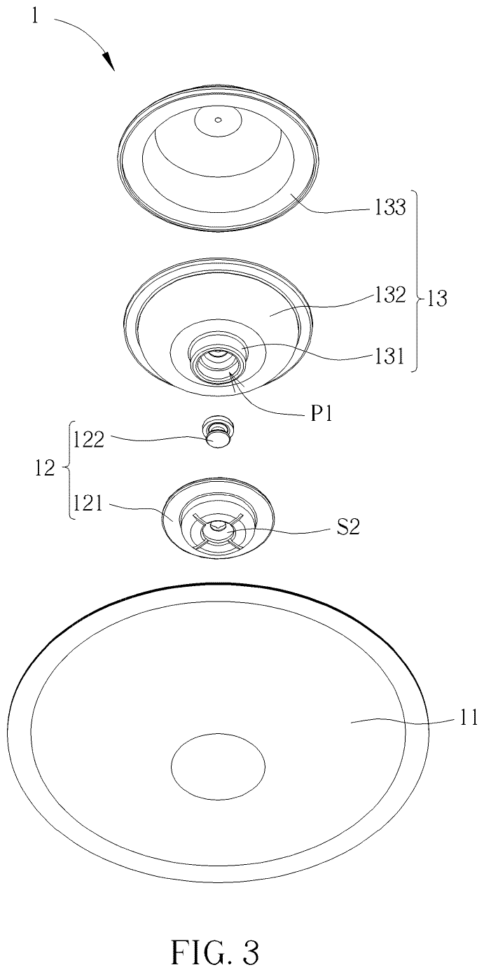

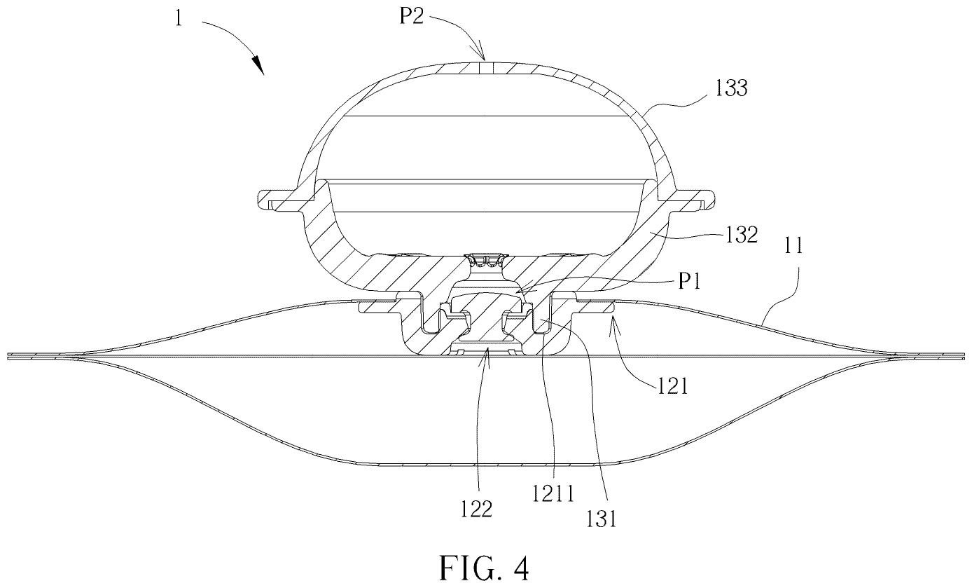

Please refer to FIG. 1 to FIG. 4. FIG. 1 is a schematic diagram of an inflation system 1 according to an embodiment of the present invention. FIG. 2 and FIG. 3 are exploded diagrams of the inflation system 1 at different views according to the embodiment of the present invention. FIG. 4 is a sectional diagram of the inflation system 1 according to the embodiment of the present invention. As shown in FIG. 1 to FIG. 4, the inflation system 1 includes a container 11, a valve assembly 12 and an inflation pump 13. The valve assembly 12 includes a seat member 121 and a valve member 122. The seat member 121 is disposed on the container 11. In this embodiment, by way of example, the container 11 can be a soft plastic bag, and the seat member 121 can be connected to the container 11 by plastic welding technology, such as laser plastic welding, high frequency plastic welding, ultrasonic plastic welding, or any other plastic welding technology. The valve member 122 is disposed through the seat member 121. The inflation pump 13 is configured to detachably engage with the seat member 121 for introducing air into the container 11.

As shown in FIG. 2 to FIG. 4, a first engaging structure 1211 is formed on the seat member 121, and a second engaging structure 131 is formed on the inflation pump 13 and configured to detachably engage with the first engaging structure 1211.

In this embodiment, by way of example, the first engaging structure 1211 is an engaging recess, and the second engaging structure 131 is an engaging protrusion. However, the present invention is not limited to this embodiment. For example, in another embodiment, the first engaging structure can be an engaging protrusion, and the second engaging structure can be an engaging recess.

As shown in FIG. 2 to FIG. 4, the inflation pump 13 includes a first resilient member 132 configured to engage with the seat member 121, and a second resilient member 133 configured to detachably mount on the first resilient member 132. An air outlet P1 is formed on the first resilient member 132, and an air inlet P2 is formed on the second resilient member 133. In this embodiment, by way of example, the air outlet P1 is surrounded by the first engaging structure 1211. The air outlet P1 is configured to at least partially receive the valve member 122 and the seat member 121 when the first resilient member 132 is engaged with the seat member 121. The aforementioned configuration allows the inflation pump 13 to pump air from an external environment into the container 11 for air inflation through repeated pressing and releasing operations.

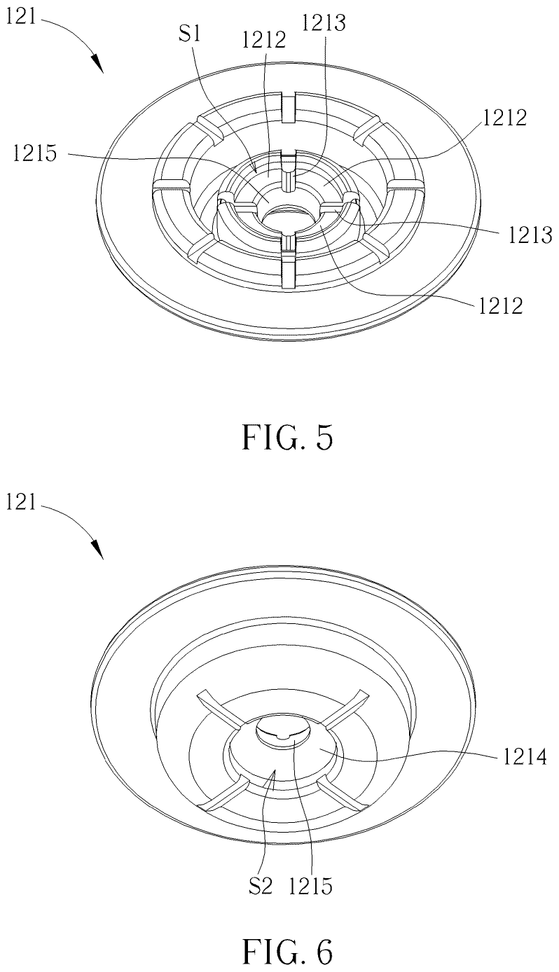

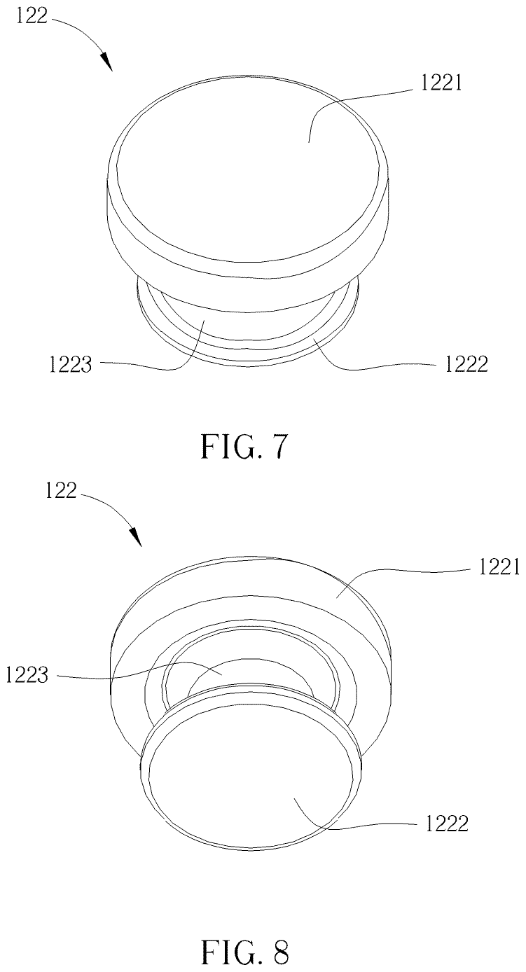

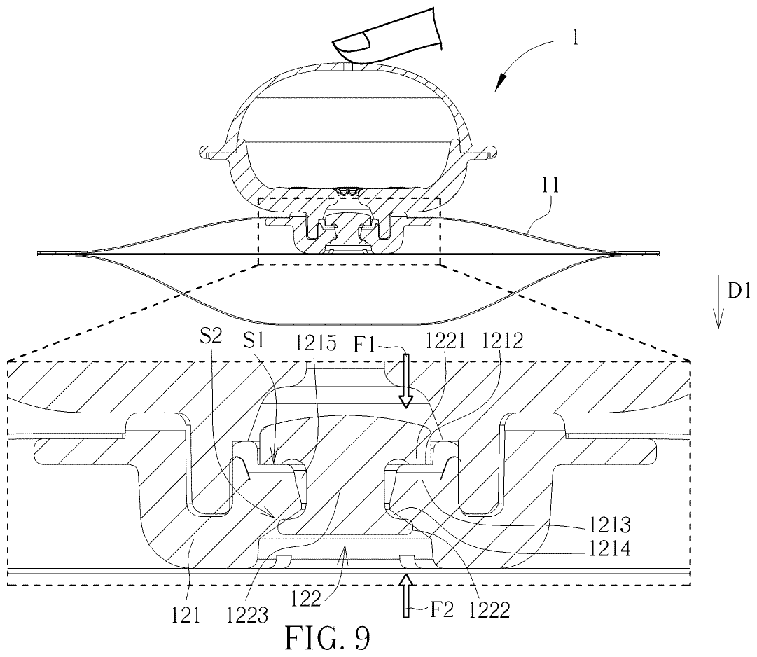

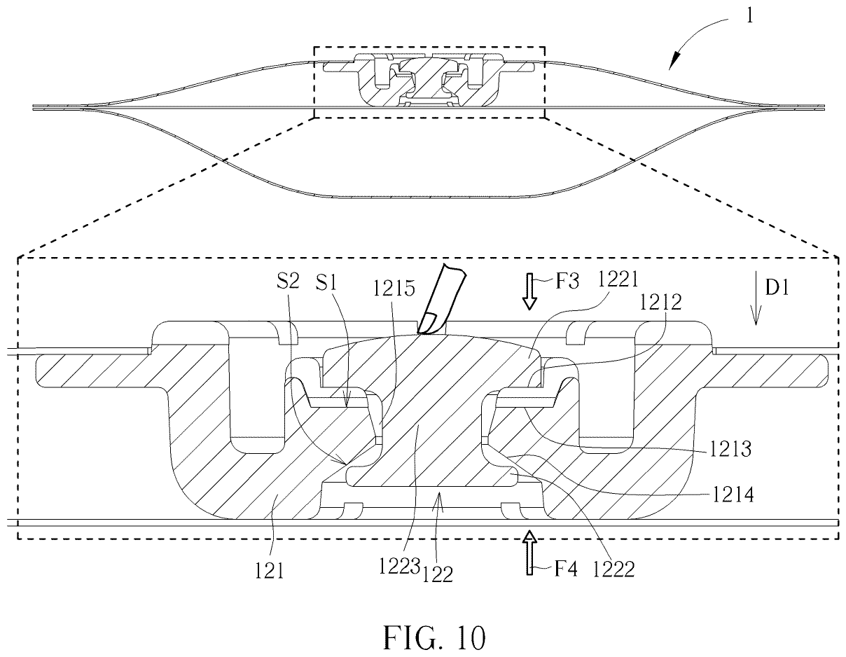

Please refer to FIG. 2 to FIG. 10. FIG. 5 and FIG. 6 are diagrams of the seat member 121 at different views according to the embodiment of the present invention. FIG. 7 and FIG. 8 are diagrams of the valve member 122 at different views according to the embodiment of the present invention. FIG. 9 is a diagram illustrating that the valve member 122 is in a first state for air inflation according to the embodiment of the present invention. FIG. 10 is a diagram illustrating that the valve member 122 is in a second state for air deflation according to the embodiment of the present invention. The valve member 122 is configured to switch between the first state (as shown in FIG. 9), which allows an airflow to flow into the container 11 in one direction only and prevents an airflow from flowing out of the container 11 for air inflation, and the second state (as shown in FIG. 10), which allows airflows to flow into and out of the container 11 in both directions for air deflation.

As shown in FIG. 9, when the valve member 122 is in the first state, the valve member 122 is configured to abut against a first side S1 and a second side S2 of the seat member 121.

Furthermore, as shown in FIG. 10, when the valve member 122 is in the second state, the valve member 122 is configured to abut against the first side S1 of the seat member 121 and separate from the second side S2 of the seat member 121.

In this embodiment, by way of example, the first side S1 and the second side S2 of the seat member 121 can be an outer side and an inner side of the seat member 121, respectively.

Preferably, the valve member 122 includes a first portion 1221, a second portion 1222 opposite to the first portion 1221, and a third portion 1223 connected between the first portion 1221 and the second portion 1222 and movably disposed through the seat member 121. When the valve member 122 is in the first state, the first portion 1221 and the second portion 1222 of the valve member 122 are configured to abut against the first side S1 and the second side S2 of the seat member 121, respectively. When the valve member 122 is in the second state, the first portion 1221 of the valve member 122 is configured to abut against the first side S1 of the seat member 121, and the second portion 1222 of the valve member 122 is configured to separate from the second side S2 of the seat member 121.

Preferably, as shown in FIG. 9 and FIG. 10, the valve member 122 is made of resilient material. The valve member 122 can switch from the first state to the second state in response to resilient deformation of the valve member 122 caused by a pressing force applied onto the first portion 1221 of the valve member 122 along a direction D1, and the valve member 122 can return from the second state to the first state in response to resilient recovery of the valve member 122 resulting from release of the pressing force.

Besides, a plurality of protruding structures 1212 are formed on the first side S1 of the seat member 121 and configured to abut against the valve member 122, i.e., the first portion 1221 of the valve member 122, and a recessed channel 1213 is formed between two adjacent protruding structures 1212 of the plurality of protruding structures 1212 and configured to provide an air passage. An inclined sealing structure 1214 is formed on the second side S2 of the seat member 121 and configured to abut against the valve member 122, i.e., the second portion 1222 of the valve member 122.

Detailed description for illustrating the valve member 122 in in different states is provided as follows.

When the valve member 122 is in the first state as shown in FIG. 9 and an airflow F1 from outside is introduced, the airflow F1 can cause the second portion 1222 of the valve member 122 to separate from the inclined sealing structure 1214 on the second side S2 of the seat member 121. Therefore, the airflow F1 can pass through the recessed channel 1213 and a gap between the second portion 1222 of the valve member 122 and the inclined sealing structure 1214 on the second side S2 of the seat member 121 separated from each other, sequentially, thereby entering the container 11. In contrast, when the valve member 122 is in the first state and an airflow F2 from inside is introduced, the airflow F2 can remain the second portion 1222 of the valve member 122 in abutment with the inclined sealing structure 1214 on the second side S2 of the seat member 121. Therefore, the airflow F2 is prevented from exiting the container 11. Accordingly, the valve member 122 in the first state allows the airflow F1 to flow into the container 11 in one direction only and prevents the airflow F2 from flowing out of the container 11.

When the valve member 122 is in the second state as shown in FIG. 10 and an airflow F3 from outside is introduced, the airflow F3 can pass through the recessed channel 1213 and the gap between the second portion 1222 of the valve member 122 and the inclined sealing structure 1214 on the second side S2 of the seat member 121 separated from each other, sequentially, thereby entering the container 11. When the valve member 122 is in the second state as shown in FIG. 10 and an airflow F4 from inside is introduced, the airflow F4 can pass through the gap between the second portion 1222 of the valve member 122 and the inclined sealing structure 1214 on the second side S2 of the seat member 121 separated from each other and the recessed channel 1213, sequentially, thereby exiting the container 11. Accordingly, the valve member 122 in the second state allows the airflows F3 and F4 to flow into and out of the container 11 in both directions.

Preferably, in order for easy assembly of the valve member 122 and the seat member 121, a tapered through hole 1215 is formed on the seat member 121 where the valve member 122, i.e., the third portion 1223 of the valve member 122, passes through, and is communicated with the first side S1 and the second side S2 of the seat member 121. A diameter of a first end of the tapered through hole 1215 adjacent to the first side S1 of the seat member 121 is less than a second end of the tapered through hole 1215 adjacent to the second side S2 of the seat member 121. An inclined wall structure of the tapered through hole 1215 and the inclined sealing structure 1214 are inclined in different directions.

In contrast to the prior art, the valve member is configured to switch from the first state to the second state in response to resilient deformation of the valve member caused by a pressing force applied onto the valve member, thereby allowing airflows to flow into and out of the container for air deflation, and the valve member is further configured to return from the second state to the first state in response to resilient recovery of the valve member resulting from release of the pressing force, thereby allowing an airflow to flow into the container and preventing an airflow from flowing out of the container for air inflation. Therefore, the present invention provides more intuitive operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inflation system comprising:
a container;
a valve assembly comprising:
a seat member disposed on the container; and
a valve member disposed through the seat member; and
an inflation pump configured to detachably engage with the seat member for introducing air into the container;
wherein when the valve member is in a first state, the valve member is configured to abut against a first side and a second side of the seat member for allowing the air to flow into the container and preventing the air from flowing out of the container;
wherein when the valve member is in a second state, the valve member is configured to abut against the first side of the seat member and separate from the second side of the seat member for allowing the air to flow into and out of the container.

2. The inflation system of claim 1, wherein the valve member is made of resilient material.

3. The inflation system of claim 1, wherein the valve member comprises a first portion, a second portion opposite to the first portion, and a third portion connected between the first portion and the second portion and movably disposed through the seat member.

4. The inflation system of claim 3, wherein when the valve member is in the first state, the first portion and the second portion of the valve member are configured to abut against the first side and the second side of the seat member, respectively.

5. The inflation system of claim 3, wherein when the valve member is in the second state, the first portion of the valve member is configured to abut against the first side of the seat member and the second portion of the valve member is configured to separate from the second side of the seat member.

6. The inflation system of claim 1, wherein a plurality of protruding structures are formed on the first side of the seat member and configured to abut against the valve member, and a recessed channel is formed between two adjacent protruding structures of the plurality of protruding structures and configured to provide an air passage.

7. The inflation system of claim 1, wherein an inclined sealing structure is formed on the second side of the seat member and configured to abut against the valve member.

8. The inflation system of claim 1, wherein a tapered through hole is formed on the seat member where the valve member passes through.

9. The inflation system of claim 1, wherein a first engaging structure is formed on the seat member, and a second engaging structure is formed on the inflation pump and configured to detachably engage with the first engaging structure.

10. The inflation system of claim 9, wherein the first engaging structure is an engaging recess, and the second engaging structure is an engaging protrusion.

11. The inflation system of claim 1, wherein the inflation pump comprises a first resilient member configured to engage with the seat member and a second resilient member configured to detachably mount on the first resilient member, an air outlet is formed on the first resilient member, and an air inlet is formed on the second resilient member.

12. The inflation system of claim 11, wherein the air outlet is configured to at least partially receive the valve member and the seat member when the first resilient member is engaged with the seat member.

13. A valve assembly adapted for a container, the valve assembly comprising:
a seat member disposed on the container; and
a valve member disposed through the seat member;
wherein when the valve member is in a first state, the valve member is configured to abut against a first side and a second side of the seat member for allowing air to flow into the container and preventing the air from flowing out of the container;
wherein when the valve member is in a second state, the valve member is configured to abut against the first side of the seat member and separate from the second side of the seat member for allowing the air to flow into and out of the container.

14. The valve assembly of claim 13, wherein the valve member is made of resilient material.

15. The valve assembly of claim 13, wherein the valve member comprises a first portion, a second portion opposite to the first portion, and a third portion connected between the first portion and the second portion and movably disposed through the seat member.

16. The valve assembly of claim 15, wherein when the valve member is in the first state, the first portion and the second portion of the valve member are configured to abut against the first side and the second side of the seat member, respectively.

17. The valve assembly of claim 15, wherein when the valve member is in the second state, the first portion of the valve member is configured to abut against the first side of the seat member and the second portion of the valve member is configured to separate from the second side of the seat member.

18. The valve assembly of claim 13, wherein a plurality of protruding structures are formed on the first side of the seat member and configured to abut against the valve member, and a recessed channel is formed between two adjacent protruding structures of the plurality of protruding structures and configured to provide an air passage.

19. The valve assembly of claim 13, wherein an inclined sealing structure is formed on the second side of the seat member and configured to abut against the valve member.

20. The valve assembly of claim 13, wherein a tapered through hole is formed on the seat member where the valve member passes through.
